(19) United States
(12) Patent Application Publication
(10) Pub. No.: US 2021/0354200 A1
(43) Pub. Date: Nov. 18, 2021

(54) ADDITIVE MANUFACTURING OF TRANSITIONED THREE-DIMENSIONAL OBJECT

(71) Applicant: Hewlett-Packard Development Company, L.P., Spring, TX (US)

(72) Inventors: Krzysztof Nauka, Palo Alto, CA (US); Chris Paul Schodin, San Diego, CA (US); John Samuel Dilip Jangam, Palo Alto, CA (US)

(73) Assignee: Hewlett-Packard Development Company, L.P., Spring, TX (US)

(21) Appl. No.: 17/258,295

(22) PCT Filed: Jan. 15, 2019
(86) PCT No.: PCT/US2019/013659

§ 371 Date: Jan. 6, 2021

(51) Int. Cl. B22F 10/14; B33Y 10/00; B33Y 30/00; B33Y 80/00; B28B 1/00; B29C 64/165

(52) U.S. Cl. CPC B22F 10/14; B33Y 10/00; B29C 64/165; B33Y 80/00; B28B 1/001; B33Y 30/00

(57) ABSTRACT

Some examples include a method of producing a three-dimensional object including successively forming a plurality of layers within a print area. The successively forming the plurality of layers within the print area includes depositing a first material including first solid particles, selectively spraying a second material on the first material, the second material including second solid particles suspended in a liquid medium, wherein the first material has a different chemical composition than the second material, and applying fusing energy to the first material and the second material in each of the plurality of layers to form the three-dimensional object including a first region comprised of the first material, a second region comprised of the second material, and a transition region comprised of the first material and the second material extending between the first and second regions.

### BACKGROUND

Additive manufacturing machines produce three dimensional (3D) objects by building up layers of material. Some 3D printing techniques are considered additive processes because they involve the application of successive layers of material. Some additive manufacturing machines are commonly referred to as “3D printers”. 3D printers and other additive manufacturing machines make it possible to convert a CAD (computer aided design) model of other digital representation of an object into the physical object.

### BRIEF DESCRIPTION OF THE DRAWINGS

FIG. 1 is a flow diagram of an example method of producing a graded three-dimensional object in accordance with aspects of the present disclosure.

FIG. 2 is a block diagram of an example additive manufacturing system useful in producing a graded three-dimensional object in accordance with aspects of the present disclosure.

FIG. 3 is a schematic diagram of an example additive manufacturing system useful in producing a graded three-dimensional object in accordance with aspects of the present disclosure.

FIGS. 4A and 4B are cross-sectional schematic diagrams of example additive manufacturing process forming a graded three-dimensional object in accordance with aspects of the present disclosure.

FIG. 5 is a perspective view schematic diagram of an example graded three-dimensional object.

### DETAILED DESCRIPTION

In the following detailed description, reference is made to the accompanying drawings which form a part hereof, and in which is shown by way of illustration specific examples in which the disclosure may be practiced. It is to be understood that other examples may be utilized and structural or logical changes may be made without departing from the scope of the present disclosure. The following detailed description, therefore, is not to be taken in a limiting sense, and the scope of the present disclosure is defined by the appended claims. It is to be understood that features of the various examples described herein may be combined, in part or whole, with each other, unless specifically noted otherwise.

Various three-dimensional printing technologies can differ in the way layers are deposited and fused, or otherwise solidified, to create a build object, as well as in the materials that are employed in each process. The descriptions and examples provided herein can be applied to various additive manufacturing technologies, environments, and materials to form a 3D object based on data of a 3D object model.

Additive manufacturing, or 3D printing, may include two processes: depositing powdery material(s) in layer-by-layer fashion and selectively fusing these layers into desired 3D object. Selective fusing can be achieved in number of ways. For example, after depositing layer of material, a binding agent is selectively printed. Then, the next layer is formed in the same fashion with the binding agent “gluing” powdery material within each layer and layer to layer. After this process is completed, the formed “green” part is annealed in the furnace causing removal of the binder and fusing of the powdery particles. This is referred to as binder jetting.

Another way to achieve selective fusing is to deposit a layer as described above, then heat point-by-point within the region defining cross-section of the printed object with a laser beam (or electron beam or ion beam) until it fuses. Repeating this process for each layer leads to the final 3D printed object (usually no need for additional furnace heating). Yet another way to achieve selective fusing is to deposit a layer, then coat it selectively with an agent enhancing or suppressing energy absorption when subsequently uniformly irradiated with a light pulse causing fusing of the powdery material. The agent can be negative (suppresses absorption)—covering region not to be fused, or positive (enhances absorption)—covering region to be fused. This method differs from the laser (or other type of beam) process because of irradiating the entire surface rather than singular point and is referred to as Jet Fusion or Photonic Fusion. Then, the next layer is deposited, and entire process repeated until completing 3D printing of desired object. The described processes can be combined. For example, Photonic Fusion can be followed by some furnace anneal, or Photonic Fusion can be combined with use of binder, etc.

Examples of the present disclosure are discussed within the context of a binder jetting additive manufacturing process. Other types of additive manufacturing processes and systems can also be employed. In an additive manufacturing process, a computer controls the spreading of build material (e.g., powder) and binding, or fusing, agents to form successive layers of material according to a digital model of a 3D object.

The present disclosure provides systems and methods for printing three-dimensional (3D) objects, or parts, with functionally graded, or gradated, features. Some 3D objects include metal materials. 3D objects produced by additive manufacturing systems, if they include any metal materials, may include a single metal material, sometimes referred to as a base metal.

Examples of the present disclosure include additive manufacturing of 3D objects including functionally graded material composition. Functionally graded, or gradated, material composition, as used herein, is a variable chemical composition across a spatial distribution of materials. Examples can include the use of ceramics, plastics, cermet (i.e., mixture of ceramic and metal particles), various metals, etc. in a single 3D build object. In accordance with aspects of the present disclosure, a spraying process can be employed to combine multiple materials into compositionally graded structures, where compositional grading may provide specific advantages not achievable by other 3D printing processes.

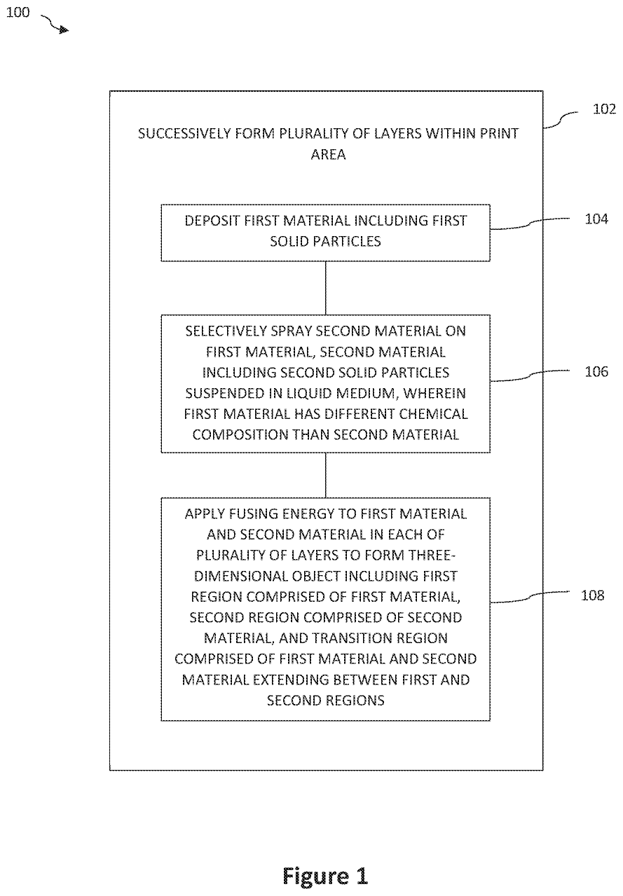

FIG. 1 is a flow diagram of an example method of producing a graded three-dimensional object in accordance with aspects of the present disclosure. At 102, a plurality of layers is successively formed within a print area. Successively forming the plurality of layers with the print area includes blocks 104-108. At 104, a first material including first solid particles is deposited. At 106, a second material is selectively sprayed on the first material. The second material includes second solid particles suspended in a liquid medium. The first material has a different chemical composition than the second material. At least one of the first solid particles and the second solid particles include metal particles. At 108, fusing energy is applied to the first material and the second material in each of the plurality of layers to form the three-dimensional object including a first region comprised of the first material, a second region comprised of the second material, and a transition region comprised of the first material and the second material extending between the first and second regions, as discussed further below.

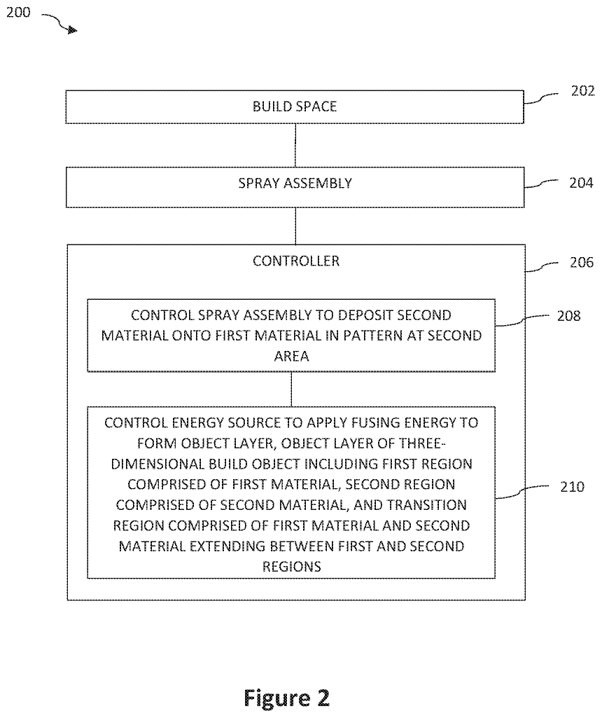

FIG. 2 is a block diagram of an example additive manufacturing system 200 in accordance with aspects of the present disclosure. Additive manufacturing system 200 includes a build space 202, a spray assembly 204, and a controller 206. Details of the various components are provided below. In general terms, however, controller 206 controls spray assembly 204 to dispense material within a build space, or build volume, 202 to form a 3D build object.

Controller 206 can be a computing device, a semiconductor-based microprocessor, a central processing unit (CPU), an application specific integrated circuit (ASIC), and/or another hardware device. Controller 206 can be in communication with a data store (not shown) that can include data pertaining to a 3D build object to be formed by the additive manufacturing system 200. Controller 206 can receive data defining an object to be printed including, for example, 3D object model data and material property (e.g., chemical property) data. In one example, the 3D object model data includes data related to the build object size, shape, position, orientation, conductivity, color, etc. The data can be received from Computer Aided Design (CAD) systems or other electronic systems useful in the creation of a three-dimensional build object. Controller 206 can manipulate and transform the received data to generate print data. Controller 206 employs the generated print data derived from the 3D object model data and material property data of the 3D build object, which may be represented as physical (electronic) quantities, in order to control elements of the additive manufacturing machine to cause delivery of build materials, binding agent, and energy to create the 3D build object.

Received build object data, including the 3D object model data, can be transformed to determine a material that corresponds to the desired chemical and mechanical properties to achieve the desired material properties (e.g., chemical properties) in the regions of the 3D build object that is/are to exhibit the desired chemical, mechanical, electrical, or structural properties, determining the material that corresponds to achieve the desired properties, or characteristics, for the desired regions(s). Machine readable instruction (stored on a non-transitory computer readable medium) can be employed to cause controller 206 to control the material that is dispensed by spray assembly 204.

In this regard, controller 206 can perform a set of functions 208-210. At 208, controller 206 controls spray assembly 204 to deposit the second material onto the first material at the second area. At 210, controller 206 controls an energy source to apply fusing energy to form the object layer. The object layer of the 3D build object includes a first region comprised of the first material, a second region comprised of the second material, and a transition region comprised of the first material and the second material extending between the first and second regions.

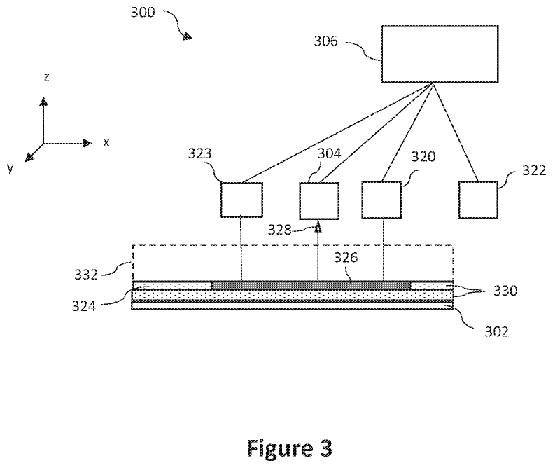

FIG. 3 is a schematic diagram of an example additive manufacturing system 300 useful in producing a graded three-dimensional object in accordance with aspects of the present disclosure. Additive manufacturing system 300 includes a build volume 332, a spray assembly 304, and a controller 306, similar to additive manufacturing system 200 of FIG. 2. Additive manufacturing system 300 can also include a fluid dispenser 320, an energy source 322 and, in some examples, a build material supply device 323 is also included. Controller 302 can manipulate and transform data, which may be represented as physical (electronic) quantities, in order to control spray assembly 304, fluid dispenser 320, energy source 322, and build material supply device 323 employed to form the 3D build object, as described further below.

In one example, a build surface 302 can be included within build space 332. In one example, build surface 302 can be separate from the build volume 332 that can be removable from additive manufacturing system 300. Build surface 302 can receive build materials, including a first material and a second material to form a three-dimensional build object. Build surface 302 can be a surface of a platen or underlying build layers of build material on a platen within a build chamber, for example. Controller 306 controls build material supply device 323 to deposit a first material 324 onto a build surface 302 to form a build material layer 330. In some examples, build material supply device 323 can include a container, a dispenser, and a distributer (e.g., roller, scraper, etc.). In some examples, build material supply device 323 is in the form of a second sprayer. In some examples, build material supply device can be included as part of spray assembly 304. Build material supply device 323 supplies and deposits successive layers of build material to within the build volume. Build material supply device 323 can be moved across a build surface 302 within the build space 332 on a carriage (not shown), for example.

First material 324 can be a powder type of build material including solid particles. First material 324 can include ceramic, metal, polymer, or composite powders (and powder-like materials), for example. In one example, more than one first material 324 can be used. First material 324 has a different chemical composition than the second material, and wherein the second material includes solid particles suspended in a liquid medium.

Spray assembly 304 is adapted to selectively deposit a second material 326 including solid particles suspended in a liquid medium onto first material 324. Spray assembly 304 can include a nozzle 328 to dispense second material 326, spray assembly 304 to maintain solid particles suspended in a liquid medium until dispensed from nozzle 328 onto the material layer based on generated print data. Controller 306 controls spray assembly 304 to selectively deposit second material 326 based on the print data. In some example, additional materials (e.g., more than one second materials 326) can also be dispensed from spray assembly 304 or from yet another spray assembly (not shown here). Second material 326, as used herein, can include one or more different independent second materials and can be singular or plural. In some examples, the same spray assembly 304 can be employed to deposit both first material 324 and second material 326. In other examples, multiple nozzles 328 are used for each of material 324, 326. Controller 306 can control spray assembly 304 to simultaneously, non-simultaneously, or partially simultaneously apply second material 326 onto build material layer 330 in one or more passes over build surface 302.

Spray assembly 304 can be carried on a moving carriage system to move across build space 332. Spray assembly 304 can be moved, or travel, in x and y axial directions. In once example, spray assembly 304 can be moved in a patterned formation (e.g., zig, zag, stepped parallel rows, etc.) to selectively dispense second material 326 onto first material 324. Second material 326 can be dispensed by spray assembly 304 in a single or multiple passes to form a build layer of a desired layer thickness. In some examples, a layer thickness of second material 326 is the same as of first material 324, thus providing planarity of the entire layer.

Second material 326 can be a mixture consisting of solid particles suspended in a liquid medium, or solvent. The solid particles can have various sizes, shapes, and material types and can include a homogeneous or heterogeneous mix of sizes, shapes, and material types. The solid particles can be metallic, ceramic, polymer, or cermet, for example. In one example, the solid particles can have a diameter of approximately 10 micrometers (μm). In some examples, water, alcohols (methanol ethanol, propanol, isopropanol, etc.), and mixture water-alcohol can be employed as mediums due to their availability, low toxicity, low surface tension, low boiling temperature and relatively high vapor pressure. Other acceptable mediums can include other simple secondary and tertiary alcohols, acetone, benzene, chloroform, ethylene glycol, kerosene, turpentine, and toluene, for example. In some examples, material 326 can include up to 60% solid particles (by volume). In one example, second material 326 includes 50% solid particles.

In order to prevent agglomeration of solid particles suspended in liquid medium, appropriate dispersants can be included. Inorganic nanoparticles can include silica, titania, and other metal oxides, for example. Organic dispersants, either anionic or cation or zwitterionic can also be used. In some examples, application of liquid soap as surfactant can visibly improve dispersion in material 326. Concentration of surfactants are desirably low enough not to affect quality of the final 3D printed object. Additional dispersion of the solid particles in material 326 can be achieved with the aid of mechanical mixers (e.g., paddles, ultrasound generator, gas bubbles blown through the liquid) mounted within a pressurized container of the spray assembly 304 (not shown).

Fluid dispenser 320 is adapted to deposit liquid agents, such as a printing agent, onto the build material layer based on generated print data. The printing agent can be a binding agent, for example. Fluid dispenser 320 can be a printhead, for example. Fluid dispenser 320 can include a single inkjet pen, for example, or multiple inkjet pens. Fluid dispenser 320 can be carried on a moving carriage system (not shown) to move across build space 332.

Controller 306 controls fluid dispenser 320 to selectively deposit printing agent based on the print data. Printing, or binding, agent can be selectively deposited on build layer 330 of first material and second material 326 to bond together the solid particles forming first material 324 to create an object layer of the 3D build object. The patterned material 324 can bond and form an object layer, or a cross-section, of a desired build object. Bonding can occur between layers as well as within layers such that a region of a lower layer that binding agent is applied bonds with adjacent regions of the layer above that binding agent was applied. Second material 326 selectively applied to first material 324 at the bonded areas (e.g., where binding agent has been applied) to bond with first material 324. Build layers 320 can include one or both of first material 324 and second material 326. The process is repeated layer by layer to complete the desired 3D build object. Transition regions including gradated proportions of first material 324 and second material 326 extend between first region formed of first material 324 and second region formed of second material 326, as discussed in more detail below.

After the object layers of the 3D build object are formed and cured, excess first material 324 can be removed (e.g., where binding agent was not applied). After this process is completed, the formed “green” 3D build object can be annealed with energy source 322 in a furnace, causing removal of the binder and fusing of the powdery particles. Alternatively, as with Photonic Fusion, for example, energy source 322 is applied layer by layer. Controller 306 controls energy source 322 to apply energy to build material in order to form the 3D object. In some examples, sintering, or full thermal fusing, can be employed to melt and fuse small grains of build material particles (e.g., powders) together and evaporate liquid medium to form a solid object. Energy source 322 can generate heat that is absorbed by components of the bonding agent and materials 324, 326 to sinter, melt, fuse, or otherwise coalesce the patterned build material. Infrared or visible light energy can be used, for example, to heat and fuse or bond the material. Energy source 322 can heat, or sinter, the cured 3D build object to a suitable temperature fully solidify to a final state.

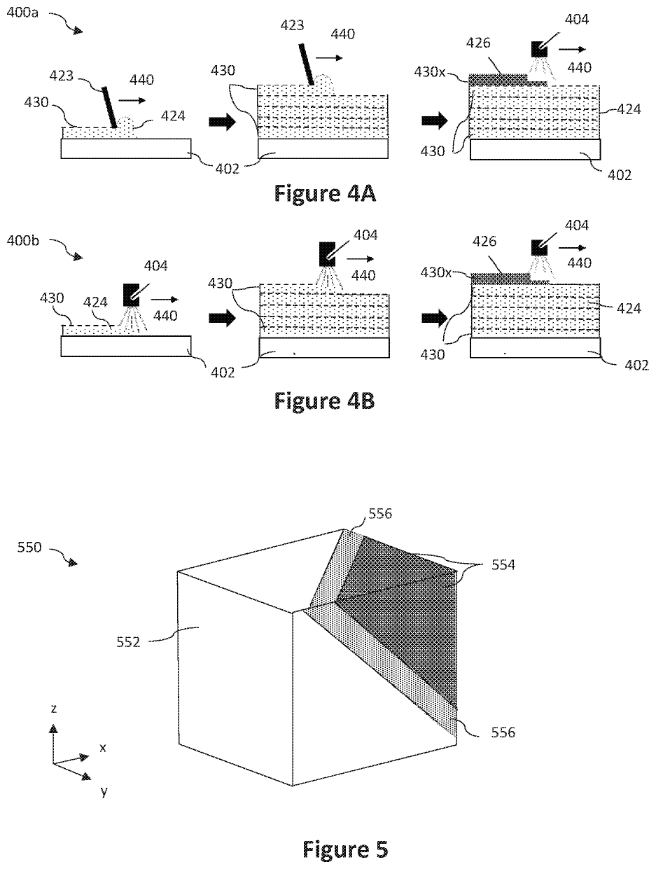

FIGS. 4A and 4B are cross-sectional schematic diagrams of example additive manufacturing process forming a functionally graded 3D build object in accordance with aspects of the present disclosure. For simplicity, binding agent application is not included in these diagrams. FIG. 4A, in the left side diagram, illustrates first material 424 deposited and then spread across build surface 402, in the direction indicated with arrow 440, with build material dispensing device 423 including a spreader (e.g., blade or roller) to form build layer 430. In another example, as illustrated in the left side diagram of FIG. 4B, first material 424 can be deposited onto build surface 402, in the direction indicated with arrow 440, with spray assembly 404 to form build layer 430. Next, in the center diagrams of FIGS. 4A and 4B, additional build layers 430 are formed of first material 424 on top of the build surface 402. Next, in the right side diagrams of FIGS. 4A and 4B, second material 426 is dispensed in build layer 430x over build layers 430 formed of first material 424 to transition build layers 430 from first material 424 to second material 426. Second material 426 is dispensed, or sprayed, onto build layer 430 with spray assembly 404. In one example, first material 424 can include stainless steel (SS) particles and second material 426 can include cobalt chromium (Co—Cr) solid particles. The cobalt chromium (Co—Cr) solid particles are suspended in a liquid medium when dispensed by spray assembly 404. In one example, first material 424 comprises the majority, or bulk, of the 3D build object and second material 426 comprises the minority of the 3D build object.

FIG. 5 is a perspective view schematic diagram of an example 3D build object 550. Build object 550 is formed during an additive manufacturing process in accordance with aspects of the present disclosure. Example build object 550 is illustrated as a cube, however, it is understood that any shape, including complex shapes, can be formed in accordance with the present disclosure. Build object 550 can be any simple or complex shape that can be manufactured in additive manufacturing system 200, 300. The shape of build object 550 illustrated in FIG. 5 is for schematic illustrative purposes only and is not to be taken in a limiting sense.

In accordance with aspects of the present disclosure, build object 550 includes a first region 552 formed with a first material, a second region 554 formed with a second material. A transition region 556 comprised of graduated proportions of the first and second materials is formed to extend between first region 552 and second region 554. Transition region 556 can include compositional grading of the first and second materials between first and second regions 552, 554 in one or more build directions. As illustrated, transition region 556 is spatially gradated in x, y, and z axial directions. Although build object 550 includes two regions 552, 554 formed of two materials (first and second materials), it is understood that additional materials and regions can be included.

Transition region 556 formed between first region 552, formed of first material, and second region 554, formed of second material, can include a series of layers with gradually changing ratio of first material to second material. For example, transition region can consist of a layer sequence such as: first material, first material, second material, first material, second material, first material, second material, second material. Grading, or gradation, of the materials between first region and second region can be accomplished by varying the amount of deposited first material and second material within selected area of each build layer. In one example, transition region 556 can be formed between first region 552 and second region 554 due to diffusion of first material and second material during the sintering which can occur at temperature/time at which both first and second materials can diffuse easily (e.g., first and second materials are both metals). In one example, solid state diffusion can occur during the application of energy from energy source to provide a smooth, or gradual, transition region 556, between first material in first region 552 and second material in second region 554.

Various applications into 3D objects formed by additive manufacturing in accordance with aspects of the present disclosure are envisioned to achieve desired material characteristics of a 3D printed object. For example, the 3D object can include a bulk of object formed with a metal first material that is formed with a surface coating of a ceramic second material to form an object with characteristics such as increased surface hardness, surface scratch resistance, thermal control through the surface. Some examples of 3D objects that this would be useful in include kitchen utensils, high speed missiles coating, etc. In other examples, a layer of a ceramic second material can be formed on the interior of a 3D object largely formed with a metal first material. In this example, characteristics such as increase mechanical strength and/or thermal control can be provided. Examples of the present disclosure include forming 3D printed objects with desired characteristics such as luster, finish, texture, wear resistance, scratch resistance, damage resistance, welding or soldering compatibility, thermal conductance or tolerance, electrical conductance or resistance, impact resistance, low cost, weight, etc. For simplicity, two materials are discussed in the above examples, however, it is understood that additional materials can be included in the 3D objects.

For example, an example 3D object formed with more than two materials in accordance with aspects of the present disclosure can include a first material having stainless steel particles to form a bar or plate, with another first or second material of ceramic particles (having heat flow control properties) forming a bottom layer, and another first or second material of nickel particles (having high shine properties) forming a top layer over the stainless steel bar or plate. Transition regions can be formed between each of the materials (e.g., stainless steel and ceramic, and stainless steel and nickel). Additional materials can be used to form other portions of the 3D object. For example, a vertical core extending through the stainless steel plate can be formed of another second material such as copper, and a ring encircling the core can be formed of another second material such as ceramic. Compositionally graded transition regions can be formed between each of the materials (e.g., copper and ceramic, and ceramic and stainless steel, etc.). Compositionally graded transition regions can be formed in any build direction through the 3D object.

Although specific examples have been illustrated and described herein, a variety of alternate and/or equivalent implementations may be substituted for the specific examples shown and described without departing from the scope of the present disclosure. This application is intended to cover any adaptations or variations of the specific examples discussed herein. Therefore, it is intended that this disclosure be limited only by the claims and the equivalents thereof.

1. A method of producing a three-dimensional object comprising:
successively forming a plurality of layers within a print area, comprising:
depositing a first material including first solid particles;
selectively spraying a second material on the first material, the second material including second solid particles suspended in a liquid medium, wherein the first material has a different chemical composition than the second material; and
applying fusing energy to the first material and the second material in each of the plurality of layers to form the three-dimensional object including a first region comprised of the first material, a second region comprised of the second material, and a transition region comprised of the first material and the second material extending between the first and second regions.

2. The method of claim 1, wherein the transition region includes the first material spatially graded to the second material transitioning from the first region to the second region.

3. The method of claim 1, wherein the selectively spraying the second material is performed with multiple passes over the first material.

4. The method of claim 1, wherein one of the first and second solid particles includes ceramic particles.

5. The method of claim 1, wherein depositing the first material includes spraying the first material with a spray assembly.

6. The method of claim 1, comprising:
selectively depositing an agent onto the first material to bind the first material at the first region, wherein the agent is selectively deposited by printing with a fluid dispenser.

7. The method of claim 1, wherein each of the first and second materials is comprised from the group of ceramic, metal, and polymers.

8. The method of claim 1, wherein the first material includes a first metal and the second material includes a second metal.

9. An additive manufactured build object, comprising:
a first portion having a first material attribute, the first material attribute obtained by an application and select fusing of a first material comprising a first solid particle; and
a second portion having a second material attribute, the second material attribute obtained by a spray application and fusing of a second material, the spray application of the second material including second solid particles suspended in a liquid medium; and
a transition portion between the first portion and the second portion, the transition portion including the first material and the second material in graded proportions.

10. The additive manufacturing build object of claim 9, wherein the first material includes a first metal and the second material includes a second metal.

11. The additive manufacturing build object of claim 9, wherein the first material includes a metal and the second material includes a ceramic.

12. The additive manufacturing build object of claim 9, wherein the transition region includes the first material spatially graded to the second material transitioning from the first region to the second region.

13. The additive manufacturing build object of claim 9, wherein each of the first and second materials is comprised from the group of ceramic and metal.

14. An additive manufacturing system comprising:
a build volume to receive a first material and a second material to form a three-dimensional build object, wherein the first material has a different chemical composition than at least the second material, and wherein at least the second material includes solid particles suspended in a liquid medium;
a spray assembly including a nozzle to dispense the second material, the spray assembly to maintain solid particles suspended in the liquid medium until dispensed from the nozzle; and
a controller to:
control the spray assembly to deposit the second material onto the first material in a pattern at the second area; and
control an energy source to apply fusing energy to form the object layer, the object layer of the three-dimensional build object including a first region comprised of the first material, a second region comprised of the second material, and a transition region comprised of graded proportions of the first material and the second material extending between the first and second regions.

15. The additive manufacturing system of claim 14, wherein the second material includes a plurality of materials suspended in the liquid medium.
